(19) United States
(12) Patent Application Publication
(10) Pub. No.: US 2025/0183451 A1
(43) Pub. Date: Jun. 5, 2025

(54) ENERGY STORAGE SYSTEM

(71) Applicant: LS ELECTRIC CO., LTD., Anyang-si, Gyeonggi-do (KR)

(72) Inventor: Dong Sik LEE, Anyang-si, Gyeonggi-do (KR)

(21) Appl. No.: 18/842,874

(22) PCT Filed: Apr. 6, 2023
(86) PCT No.: PCT/KR2023/004661

§ 371 Date: Aug. 30, 2024

(30) Foreign Application Priority Data
Apr. 7, 2022 (KR) 10-2022-0043389

(51) Int. Cl. H01M 50/251; H01M 50/204; H01M 50/262

(52) U.S. Cl. CPC H01M 50/251; H01M 50/204; H01M 50/262

(57) ABSTRACT

An energy storage system may comprise: a plurality of battery modules; and a rack-integrated enclosure within which the plurality of battery modules are accommodated, wherein the rack-integrated enclosure comprises an enclosure part forming the external appearance and having an inner space in which a plurality of batteries are accommodated, and a rack part formed integrally with the enclosure part, and the rack part comprises: a plurality of shelf supporters vertically arranged across the space and spaced apart from each other in the forward-and-backward direction; a plurality of shelfs arranged on the shelf supporters to be vertically spaced apart from each other; and horizontal supporters connecting the plurality of shelf supporters to each other.

### TECHNICAL FIELD

The present disclosure relates to an energy storage system.

### BACKGROUND ART

An energy storage system, which is a system that stores and manages energy to efficiently use the energy, is utilized in a power plant, a transmission and distribution facility, a home, a factory, and a company.

Based on a method of storing energy, the energy storage system may be divided into a battery type that uses a secondary battery such as a lithium battery (LiB), a redox flow battery, a sodium-sulfur (NaS) battery, and a super capacitor, and a non-battery type that uses compressed air energy storage (CAES).

Among them, a battery type energy storage system may include a plurality of battery modules. The plurality of battery modules may be stacked vertically on a rack accommodated inside an enclosure.

An example of an energy storage system using a rack is a power storage device including a battery rack disclosed in Korean Patent Publication No. 10-2020-0100407 A (published on Aug. 26, 2020). In the prior literature, the battery rack includes a plurality of battery modules each provided with one or more secondary batteries to store and release energy, electrically connected to one another, and stacked in a top-bottom direction with a bottom surface inclined with respect to a horizontal plane, and a rack case that accommodates the plurality of battery modules and has escape parts provided on a portion facing lower side surfaces of the plurality of battery modules and configured to be opened by heat or pressure applied from at least one battery module.

### DISCLOSURE OF INVENTION

### Technical Problem

An aspect of the present disclosure is to provide an energy storage system with improved structural safety.

### Solution to Problem

An energy storage system may include a plurality of battery modules; and a rack-integrated enclosure that accommodates a plurality of battery modules thereinside, wherein the rack-integrated enclosure includes an enclosure part constituting an outer shape and having a space that accommodates the plurality of battery modules; and a rack part disposed integrally in the enclosure part, the rack part includes a plurality of shelf supporters disposed vertically across the space and spaced apart from one another in a front-rear direction; and a plurality of shelves disposed to be spaced apart from one another in a top-bottom direction at the shelf supporters and a horizontal supporter connecting the plurality of shelf supporters to one another.

The shelf may include a left shelf disposed at a left side of the shelf supporter; and a right shelf disposed at a right side of the shelf supporter, wherein the left shelf and the right shelf are spaced apart in a left-right direction.

The enclosure part may include a base; a top plate spaced apart from the base in a top-bottom direction at an upper side of the base; and a vertical frame connecting the base to the top plate, wherein a bottom of the shelf supporter is connected to the base, and a top of the shelf supporter is connected to the horizontal supporter.

The plurality of shelf supporters may include a front supporter and a rear supporter spaced apart in a front-rear direction; and a center supporter spaced apart from each of the front supporter and the rear supporter in the front-rear direction.

An energy storage system according to another embodiment of the present disclosure may include a plurality of battery modules; an enclosure having a space disposed thereinside; and a rack accommodated in the space to accommodate the plurality of battery modules, wherein an enclosure bracket protrudes downward from a top plate of the enclosure, a rack bracket protrudes upward from an upper plate of the rack, and the enclosure bracket and the rack bracket are connected by a coupler.

The top plate of the enclosure and the upper plate of the rack may be spaced apart in a top-bottom direction.

A gap larger than a height of the coupler may be formed between the top plate of the enclosure and the upper plate of the rack.

A first fastening hole may be disposed in the enclosure bracket, wherein a second fastening hole is disposed in the rack bracket, and the coupler is disposed with an upper fastening hole that matches the first fastening hole and a lower fastening hole that matches the first fastening hole or the second fastening hole.

The upper fastening hole and the lower fastening hole may be spaced apart in a top-bottom direction.

When the rack is accommodated in the space, a lower end of the enclosure bracket and an upper end of the rack bracket may be spaced apart in a top-bottom direction.

### Advantageous Effects of Invention

According to embodiments, an enclosure part and a rack part may be integrally disposed, and supported not only in a top-bottom direction but also in a horizontal direction by a shelf supporter and a horizontal supporter of the rack part, thereby minimizing a distortion in upward, downward, leftward, and rightward directions, and improving assembly safety.

In addition, an enclosure bracket disposed in an enclosure and a rack bracket disposed in a rack may be fixed by a coupler, thereby fixing the enclosure and the rack up and down, and stably supporting the rack in the enclosure.

### BRIEF DESCRIPTION OF DRAWINGS

FIG. 1 is a perspective view of an energy storage system according to one embodiment.

FIG. 2 is a perspective view of a rack-integrated enclosure according to one embodiment.

FIG. 3 is a view showing an example of a battery module disposed in a rack-integrated enclosure according to one embodiment.

FIG. 4 is a perspective view of an energy storage system according to another embodiment.

FIG. 5 is a front view of an enclosure according to another embodiment.

FIG. 6 is a view when a rack according to another embodiment is disposed inside an enclosure.

FIG. 7 is a view when a coupler shown in FIG. 6 is fastened to a rack bracket and an enclosure bracket.

### MODE FOR THE INVENTION

Hereinafter, a specific embodiment of the present disclosure will be described in detail with respect to the accompanying drawings.

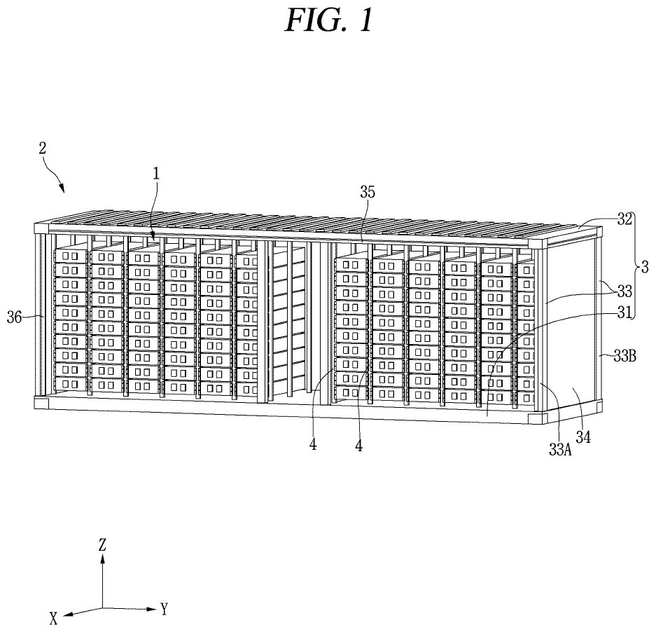

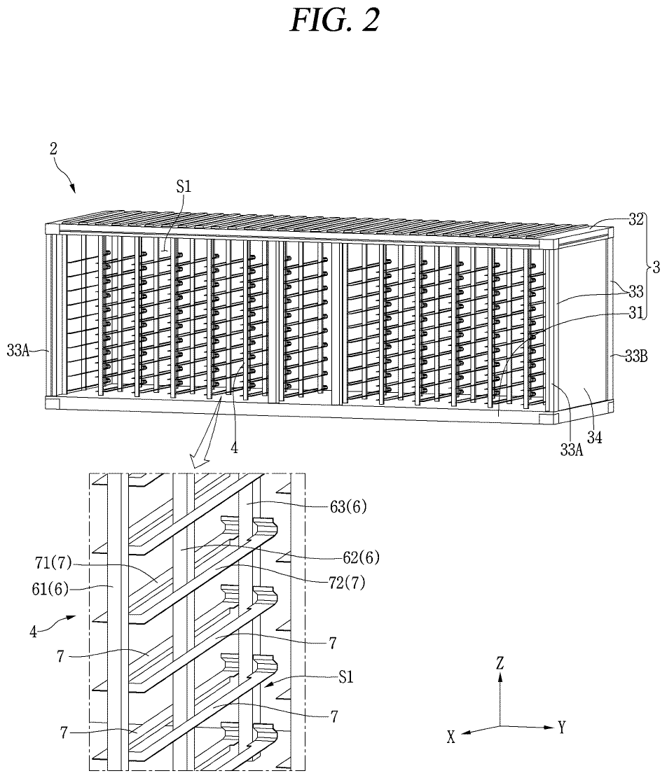

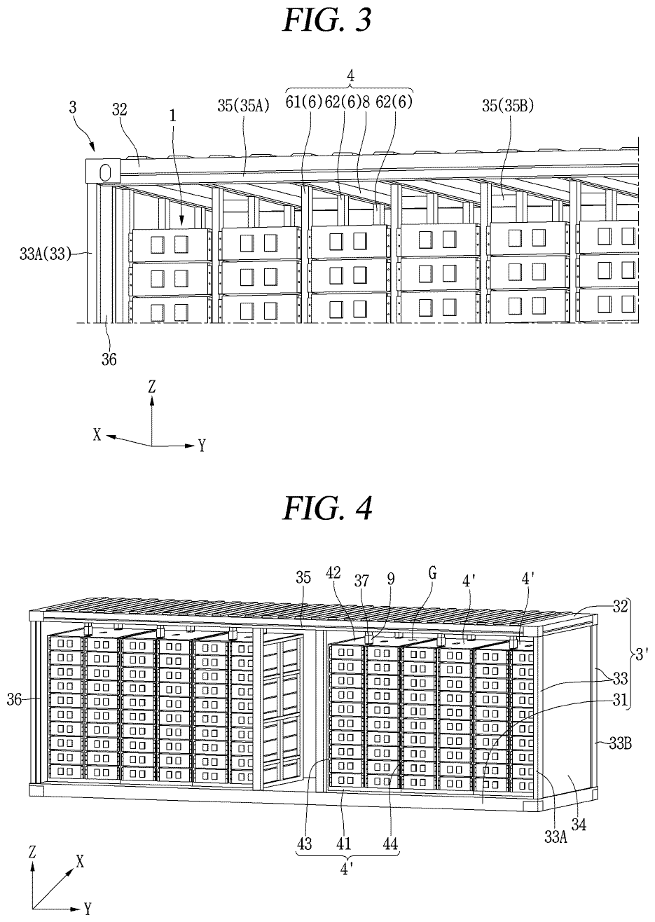

FIG. 1 is a perspective view of an energy storage system according to one embodiment, FIG. 2 is a perspective view of a rack-integrated enclosure according to one embodiment, and FIG. 3 is a view showing an example of a battery module disposed in a rack-integrated enclosure according to one embodiment.

Referring to FIGS. 1 to 3, the energy storage system according to this embodiment may include a plurality of battery modules 1 and a rack-integrated enclosure 2.

The plurality of battery modules 1 may be stacked vertically inside the rack-integrated enclosure 2. The plurality of battery modules 1 may be respectively seated and supported in the rack-integrated enclosure 2, and may be stacked in a line in a top-bottom direction Z. The battery modules 1 may be disposed in a plurality of lines in a left-right direction Y.

The plurality of battery modules 1 may be accommodated inside the rack-integrated enclosure 2.

As shown in FIGS. 2 and 3, the rack-integrated enclosure 2 may include an enclosure part 3 and a rack part 4. The enclosure part 3 and the rack part 4 may be integrally disposed.

The enclosure part 3 may constitute an outer shape of the rack-integrated enclosure 2. A space S1 in which the plurality of battery modules 1 are accommodated may be formed inside the enclosure part 3.

The enclosure part 3 may be disposed to have a length in a left-right direction Y, which is greater than a width in a front-rear direction X.

As shown in FIG. 2, the enclosure part 3 may include a base 31, a top plate 32, and a vertical frame 33.

The top plate 32 may be disposed at an upper side of the base 31. The top plate 32 may be disposed to be spaced apart from the base 31 in the top-bottom direction Z.

The vertical frame 33 may connect the base 31 to the top plate 32. The vertical frame 33 may be provided on the base 31 to support the top plate 32. The vertical frame 33 may be provided in plurality at an upper side of the base 31.

The vertical frame 33 each may include a front vertical frame 33A and a rear vertical frame 33B. The rear vertical frame 33B may be spaced apart from the front vertical frame 33A in the front-rear direction X.

The enclosure part 3 may further include a side plate 34 connecting the front vertical frame 33A to the rear vertical frame 33B.

The front vertical frame 33A, the rear vertical frame 33B, and the side plate 34 may be provided on the left and right sides of the enclosure part 3, respectively.

The front vertical frame 33A may include a left front vertical frame and a right front vertical frame spaced apart in the left-right direction Y.

The rear vertical frame 33B may include a left rear vertical frame and a right rear vertical frame spaced apart in the left-right direction Y.

The side plate 34 may include a left plate and a right plate spaced apart in the left-right direction Y.

The rack part 4 may be disposed integrally with the enclosure part 3. The rack part 4 may be disposed inside the enclosure part 3.

The rack part 4 may include a plurality of shelf supporters 6, a plurality of shelves 7, and a horizontal supporter 8.

Each of the shelf supporters 6 may be disposed across the space S1 in the top-bottom direction Z. A bottom of the shelf supporter 6 may be connected to the base 31, and a top of the shelf supporter 6 may be connected to the horizontal supporter 8.

The plurality of shelf supporters 6 may be spaced apart from one another in the front-rear direction X.

Each of the shelf supporters 6 may include a front supporter 61, a center supporter 62, and a rear supporter 63.

The front supporter 61 and the rear supporter 63 may be spaced apart in the front-rear direction X.

The center supporter 62 may be located between the front supporter 61 and the rear supporter 62. The center supporter 62 may be spaced apart from each of the front supporter 61 and the rear supporter 62 in the front-rear direction X.

The front supporter 61, the center supporter 62, and the rear supporter 63 may constitute a single shelf supporter group. A plurality of shelf supporter groups may be disposed inside the enclosure 3, and the plurality of shelf supporter groups may be spaced apart in the left-right direction Y.

The plurality of battery modules 1 may be accommodated between the plurality of shelf supporter groups.

The plurality of shelves 7 may be disposed on the shelf supporters 6 to be spaced apart from each other in the top-bottom direction Z. The shelf 7 may include a left shelf 71 disposed at a left side of the shelf supporter 6 and a right shelf 72 disposed at a right side of the shelf supporter.

The left shelf 71 and the right shelf 72 may be spaced apart in a left-right direction.

The left shelf 71 and the right shelf 72 may be provided for each of the plurality shelf supporter groups. The battery module 1 may be disposed on the right shelf 72 in one group of the plurality of shelf supporter groups and the left shelf 71 in the other group of the plurality of shelf supporter groups.

The horizontal supporter 8 may connect the plurality of shelf supporters 6 to one another. The horizontal supporter 8 may be disposed inside the enclosure 3 in the front-rear direction X.

As shown in FIGS. 1 and 3, the enclosure 3 may further include an upper frame 35.

The upper frame 35 may be disposed at a bottom of the top plate 32 of the enclosure 3. The upper frame 35 may include a front upper frame 35A and a rear upper frame 35B. The front upper frame 35A and the rear upper frame 35B may be spaced apart in the front-rear direction X.

The horizontal supporter 8 may be connected to the upper frame 35. A front end of the horizontal supporter 8 may be connected to the front upper frame 35A, and a rear end of the horizontal supporter 8 may be connected to the rear upper frame 35B. The horizontal supporter 8 may be disposed between the front upper frame 35A and the rear upper frame 35B.

The enclosure 3 may further include an inner frame 36, as shown in FIGS. 1 and 3.

The inner frame 36 may be disposed at one side of the vertical frame 33 of the enclosure 3.

A lower end of the inner frame 36 may be connected to the base 31. An upper end of the inner frame 36 may be connected to the upper frame 35.

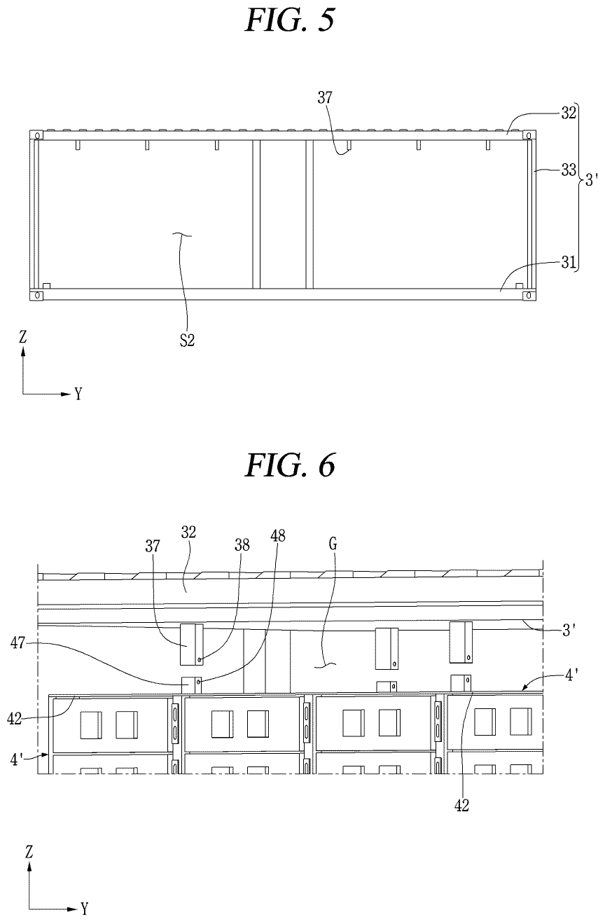

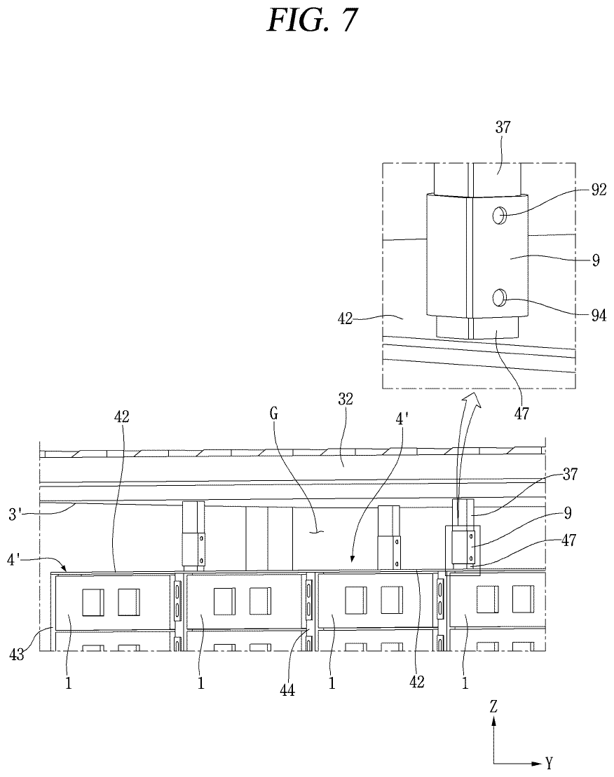

FIG. 4 is a perspective view of an energy storage system according to another embodiment, FIG. 5 is a front view of an enclosure according to another embodiment, FIG. 6 is a view when a rack according to another embodiment is disposed inside an enclosure, and FIG. 7 is a view when a coupler shown in FIG. 6 is fastened to a rack bracket and an enclosure bracket.

Referring to FIGS. 4 to 7, an energy storage system according to another embodiment may include a plurality of battery modules 1, an enclosure 3′, a rack 4′, and a coupler 9.

A space S2 (see FIG. 5) may be disposed inside the enclosure 3′, and a plurality of racks 4′ may be accommodated in the space S2. The enclosure 3′ may include a base 31, a top plate 32, and a vertical frame 33. The enclosure 3′ may further include an upper frame 35 and an inner frame 36.

The base 31, the top plate 32, the vertical frame 33, the upper frame 35, and the inner frame 36 are the same or similar to the embodiment shown in FIGS. 1 to 3, and thus a redundant description thereof will be omitted.

An enclosure bracket 37 may protrude downward from the top plate 32 of the enclosure 3′. The enclosure bracket 37 may be fixed to the rack 4′. The enclosure bracket 37 may protrude toward the rack 4′. The enclosure bracket 37 may protrude toward the space S2.

The configuration of the enclosure 3′ is the same as or similar to that of the enclosure 3 shown in FIGS. 1 to 3, except that the enclosure bracket 37 is further disposed on the top plate 32.

The rack 4′ may be manufactured separately from the enclosure 3′, then inserted into and accommodated in the space S2 of the enclosure 3′, and coupled to the enclosure 3′. An energy storage system according to another embodiment may include a plurality of racks 4′ accommodated inside the enclosure 3′.

The plurality of battery modules 1 may be accommodated in the rack 4′. The plurality of battery modules 1 may be stacked vertically inside the rack 4′. The plurality of battery modules 1 may be respectively seated and supported in the rack 4′, and may be stacked in a line in a top-bottom direction Z. The battery modules 1 may be disposed in a plurality of lines in a left-right direction Y inside the rack 4′.

The rack 4′ may include a lower body 41, an upper plate 42, and a pair of side bodies 43, 44. A space in which the plurality of battery modules 1 are accommodated may be formed inside the rack 4′.

The rack 4′ may have a hexahedral shape with a space disposed thereinside.

When the rack 4′ is inserted into the space S2 of the enclosure 3′, the lower body 41 of the rack 4′ may be seated on the base 31.

When the rack 4′ is inserted into the space S2 of the enclosure 3′, the upper plate 42 of the rack 4′ may be spaced apart in the top-bottom direction Z from the top plate 32 of the enclosure 3′.

A gap G larger than a height of the coupler 9 may be formed between the top plate 32 of the enclosure 3′ and the upper plate 42 of the rack 4′.

A rack bracket 47 may protrude upward from the upper plate 42 of the rack 4′.

The rack bracket 47 may be connected to the enclosure 3′ by a coupler 9. The rack bracket 47 may protrude toward the enclosure 3′. The rack bracket 47 may protrude toward the enclosure bracket 37.

When the rack 4′ is accommodated in the space S2 of the enclosure 3′, a lower end of the enclosure bracket 37 and an upper end of the rack bracket 47 may be spaced apart in the top-bottom direction Z.

A height (length in the top-bottom direction Z) of the coupler 9 is less than a height (length in the top-bottom direction Z) of the gap G formed between the top plate 32 of the enclosure 3′ and the upper plate 42 of the rack 4′.

The coupler 9 may connect the enclosure bracket 37 to the rack bracket 47. The coupler 9 may be formed in a hollow shape. A bottom of the enclosure bracket 37 may be inserted into the coupler 9, and a top of the rack bracket 47 may be inserted into the coupler 9.

Each of the enclosure bracket 37, the rack bracket 47, and the coupler 9 may be formed in a polygonal shape, such as a rectangular parallelepiped shape.

The coupler 9 and the enclosure bracket 37 may be fixed to each other by fastening members such as screws or bolts. A first fastening hole 38 (FIG. 6) into which a fastening member is inserted may be disposed in the enclosure bracket 37.

The coupler 9 and the rack bracket 47 may be fixed to each other by fastening members such as screws or bolts. A second fastening hole 48 (see FIG. 6) into which a fastening member is inserted may be formed in the rack bracket 47.

An upper fastening hole 92 (see FIG. 7) that matches the first fastening hole 38 and a lower fastening hole 94 (see FIG. 7) that matches the second fastening hole 48 may be disposed in the coupler 9.

The upper fastening hole 92 and the lower fastening hole 94 may be spaced apart in the top-bottom direction Z.

The coupler 9 may be fastened to the enclosure bracket 37 prior to being accommodated in the space S2 of the enclosure 3′. The lower fastening hole 94 of the coupler 9 and the first fastening hole 38 of the enclosure bracket 37 may match each other, and fastening members such as screws or bolts may be inserted into the lower fastening hole 94 and the first fastening hole 38. The coupler 9 may be temporarily fastened at a height where the lower fastening hole 94 matches the first fastening hole 38.

When the lower fastening hole 94 of the coupler 9 is located at a height that matches the first fastening hole 38, the rack 4′ may be inserted into and accommodated in the space S2 of the enclosure 3′ without allowing the coupler 9 to interfere with the insertion of the rack 4′.

A worker may align the rack 4′ such that the rack bracket 47 is located below the enclosure bracket 37. The worker may loosen fastening members such as screws or bolts inserted into the lower fastening hole 94 and the first fastening hole 38, and the coupler 9 may be lowered.

When the coupler 9 is lowered, the top of the rack bracket 47 may be inserted into the coupler 9.

The worker may insert fastening members such as screws or bolts into the first fastening hole 38 and the upper fastening hole 92 while the first fastening hole 38 of the enclosure bracket 37 is aligned with the upper fastening hole 92 of the coupler 9, thereby allowing the enclosure bracket 37 and the coupler 9 to be fixed to each other.

Furthermore, the worker may insert fastening members such as screws or bolts into the second fastening hole 48 and the lower fastening hole 94 while the second fastening hole 48 of the rack bracket 47 is aligned with the lower fastening hole 94 of the coupler 9, thereby allowing the rack bracket 47 and the coupler 9 to be fixed to each other.

The foregoing description has merely described the technical concept of the present disclosure in an exemplary manner, and it will be apparent to those skilled in this art that various changes and modifications may be made thereto without departing from the gist of the present disclosure.

Accordingly, it should be noted that the embodiments disclosed in the present disclosure are only illustrative and not limitative to the technical concept of the present disclosure, and the scope of the technical concept of the present disclosure is not limited by those embodiments.

The protection scope of the present disclosure should be construed by the accompanying claims, and all the technical concept within the equivalent scope of the disclosure should be construed to be included in the right scope of the present disclosure.

1. An energy storage system comprising:
a plurality of battery modules; and
a rack-integrated enclosure that accommodates a plurality of battery modules thereinside,
wherein the rack-integrated enclosure comprises:
an enclosure part constituting an outer shape and having a space that accommodates the plurality of battery modules; and
a rack part disposed integrally in the enclosure part, and
wherein the rack part comprises:
a plurality of shelf supporters disposed vertically across the space and spaced apart from one another in a front-rear direction; and
a plurality of shelves disposed to be spaced apart from one another in a top-bottom direction at the shelf supporters and a horizontal supporter connecting the plurality of shelf supporters to one another.

2. The energy storage system of claim 1, wherein the shelf comprises:
a left shelf disposed at a left side of the shelf supporter; and
a right shelf disposed at a right side of the shelf supporter, and
wherein the left shelf and the right shelf are spaced apart in a left-right direction.

3. The energy storage system of claim 1, wherein the enclosure part comprises:
a base;
a top plate spaced apart from the base in a top-bottom direction at an upper side of the base; and
a vertical frame connecting the base to the top plate,
wherein a bottom of the shelf supporter is connected to the base, and
wherein a top of the shelf supporter is connected to the horizontal supporter.

4. The energy storage system of claim 1, wherein the plurality of shelf supporters comprises:
a front supporter and a rear supporter spaced apart in a front-rear direction; and
a center supporter spaced apart from each of the front supporter and the rear supporter in the front-rear direction.

5. An energy storage system comprising:
a plurality of battery modules;
an enclosure having a space disposed thereinside; and
a rack accommodated in the space to accommodate the plurality of battery modules,
wherein an enclosure bracket protrudes downward from a top plate of the enclosure,
wherein a rack bracket protrudes upward from an upper plate of the rack, and
wherein the enclosure bracket and the rack bracket are connected by a coupler.

6. The energy storage system of claim 5, wherein the top plate of the enclosure and the upper plate of the rack are spaced apart in a top-bottom direction, and
wherein a gap larger than a height of the coupler is formed between the top plate of the enclosure and the upper plate of the rack.

7. The energy storage system of claim 5, wherein a first fastening hole is disposed in the enclosure bracket,
wherein a second fastening hole is disposed in the rack bracket, and
wherein the coupler is disposed with an upper fastening hole that matches the first fastening hole and a lower fastening hole that matches the first fastening hole or the second fastening hole.

8. The energy storage system of claim 7, wherein the upper fastening hole and the lower fastening hole are spaced apart in a top-bottom direction.

9. The energy storage system of claim 5, wherein when the rack is accommodated in the space, a lower end of the enclosure bracket and an upper end of the rack bracket are spaced apart in a top-bottom direction.
